(19) United States
(12) Patent Application Publication
(10) Pub. No.: US 2014/0026639 A1
(43) Pub. Date: Jan. 30, 2014

(54) SYSTEM AND METHOD FOR PHOTOACOUSTIC GAS ANALYSIS

(71) Applicants: Xuefeng Wang, Niskayuna, NY (US); Boon Kwee Lee, Clifton Park, NY (US)

(72) Inventors: Xuefeng Wang, Niskayuna, NY (US); Boon Kwee Lee, Clifton Park, NY (US)

(73) Assignee: GENERAL ELECTRIC COMPANY, Schenectady, NY (US)

(21) Appl. No.: 13/561,501

(22) Filed: Jul. 30, 2012

(51) Int. Cl. G01N 21/17

(52) U.S. Cl. 73/24.02

(57) ABSTRACT

A system for analyzing gas concentrations in a gas mixture includes an array of semiconductor light sources which are configured to generate an electromagnetic radiation having a narrow bandwidth. A controller modulates the electromagnetic radiation at a modulating frequency to provide light pulses at an absorption wavelength of at least one target gas. The system also includes an acoustic resonant gas chamber to hold the gas mixture and configured to receive the light pulses and amplify acoustic signals emanating from the gas mixture. A processor determines a concentration of the target gas based on acoustic signals.

### BACKGROUND

Embodiments of the invention relate generally to a system and method for detecting and monitoring gases, and more specifically for detecting and monitoring one or more target gases in a gas mixture, for example dissolved gases extracted from a fluid, such as transformer oil, or exhaust gas from a combustion process.

Electrical equipment, particularly medium-voltage or high-voltage electrical distribution equipment such as transformers require a high degree of electrical and thermal insulation between components. Accordingly, it is well known to encapsulate components of electrical equipment, such as coils of a transformer, in a containment vessel and to fill the containment vessel with a fluid. The fluid facilitates dissipation of heat generated by the components and can be circulated through a heat exchanger to efficiently lower the operating temperature of the components. The fluid also serves as electrical insulation between components or to supplement other forms of insulation disposed around the components, such as cellulose paper or other insulating materials. Any fluid having the desired electrical and thermal properties can be used. Typically, electrical equipment is filled with oil, such as castor oil or mineral oil, or synthetic “oil” such as chlorinated biphenyl, silicone oil, or sulfur hexafluoride.

Often electrical distribution equipment is used in a mission critical environment in which failure can be very expensive or even catastrophic because of a loss of electric power to critical systems. Also, failure of electrical distribution equipment ordinarily results in a great deal of damage to the equipment itself and surrounding equipment, thus requiring replacement of expensive equipment. Further, such failure can cause injury to personnel due to electric shock, fire, or explosion. Therefore, it is desirable to monitor the status of electrical equipment to predict potential failure of the equipment through detection of incipient faults and to take remedial action through repair, replacement, or adjustment of operating conditions of the equipment. It is well known that under fault condition, certain signature gases will be discharged into the transformer oil, for example, in high energy arcing or overheating fault, acetylene will be generated and discharged into transformer oil. Therefore, by extracting and detecting these target gases, transformer health conditions can be monitored.

In another embodiment, monitoring the composition and concentration of exhaust gas from a combustion equipment or process, such as furnaces, boilers, etc. can be used to evaluate operating efficiency and/or safety risks in real-time. For example, carbon monoxide and carbon dioxide concentration and/or their ratios in exhaust gas can be used to determine combustion efficiency. In yet another example, monitoring carbon monoxide concentration in furnace exhaust gas or in furnace vent system is important to prevent carbon monoxide poisoning of people in surrounding environment.

For these and other reasons, there is a need for embodiments of the present invention.

### BRIEF DESCRIPTION

In accordance with an embodiment of the present invention, a system for analyzing gas concentrations in a gas mixture is provided. The system includes an array of semiconductor light sources configured to generate an electromagnetic radiation having a narrow bandwidth and a controller to modulate the electromagnetic radiation at a modulating frequency to provide light pulses at an absorption wavelength of at least one target gas. The system also includes an acoustic resonant gas chamber to hold the gas mixture and configured to receive the light pulses and amplify acoustic signals emanating from the gas mixture and a processor to determine a concentration of the target gas based on acoustic signals.

In accordance with another embodiment of the present invention, a method of monitoring dissolved gases in a fluid is provided. The method includes utilizing an array of semiconductor light sources to generate an electromagnetic radiation having a narrow bandwidth and receiving the electromagnetic radiation in an acoustic resonant gas chamber holding a gas mixture extracted from the fluid. The acoustic resonant gas chamber is designed to amplify acoustic signals emanating from the gas mixture. The method also includes modulating the electromagnetic radiation to provide light pulses at an absorption wavelength of at least one target gas and determining a concentration of the target gas dissolved in the fluid based on the acoustic signals.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of a system for analyzing gas concentrations in accordance with an embodiment of the present system;

FIG. 2 is a schematic diagram of an IR light source of FIG. 1 and a graphical illustration of a resultant light signal plot in accordance with an embodiment of the present system;

FIG. 3 is a schematic diagram of a representative acoustic resonant gas chamber of FIG. 1 in accordance with an embodiment of the present invention; and

FIG. 4 is a flow chart illustrating a method of monitoring gas concentration in accordance with an embodiment of the present system.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The invention includes embodiments that relate to a method and a system for detecting and monitoring dissolved gases in a fluid, for example transformer oil or cooling fluid. As discussed in detail below, some of the embodiments of the present invention provide a method for detecting and monitoring dissolved gases by using photoacoustics and a system for the same.

Though the present discussion provides examples in the context of a gas mixture in the electric power industry, typically an extracted gas from transformer oil, these processes can be applied to any other gas or application. In some embodiments, the gas mixture may include acetylene, methane, ethane, carbon monoxide, carbon dioxide, or the like. The method and device described herein may be used in other industries such as the chemical industry, energy industry, aviation industry, and food industry.

Some embodiments of the invention provide a method for detecting and monitoring a selected gas in a fluid using photoacoustics. The method involves the steps of irradiating a gas mixture with an electromagnetic radiation, monitoring an acoustic signal emanating from the vibrations or pressure variations in the gas chamber which occur due to its energy absorption by gas molecules, and determining a concentration of the gas as a function of the amplitude and/or phase of the acoustic signal. The gas mixture is irradiated with a radiation at a wavelength or wavelengths corresponding to a spectral absorption range of a selected gas or gases.

In some other embodiments, the gas may absorb a substantial or partial amount of radiation of a particular wavelength. In such instances, the radiation absorption results in excitation and heating of gas molecules which causes instantaneous pressure increase in the gas absorption chamber. When the electromagnetic radiation such as incident light is being modulated at a given frequency, a periodic pressure variation is generated. The periodic pressure variations are detected by a microphone and then the concentration of the gas as a function of the variation in the periodic pressure is detected.

FIG. 1 is a schematic diagram of a system 10 for analyzing gas concentrations in a gas mixture in accordance with an embodiment of the present invention. System 10 includes an acoustic resonant gas chamber 12 with an inlet 14 and an outlet 16. A sample gas mixture such as an extracted gas mixture from transformer oil is pumped into acoustic resonant gas chamber 12 through inlet 14 and flows out from outlet 16. An electromagnetic radiation source 18 such as infrared (IR) light source emits IR light signals or electromagnetic radiations into the gas mixture through an aperture 20 in acoustic resonant gas chamber 12. The resulting pressure variations in the gas mixture due to energy absorption by gas molecules are measured by an acoustic sensor or an acoustic transducer 22. Acoustic signals from acoustic sensor 22 are then transmitted to a processor 24 for analyzing a target gas concentration in the gas mixture.

IR light source 18 is modular and reconfigurable according to customer choice of gases. In other words, if detection of a specific gas or gases is needed, then IR light source 18 can be re-configured to include additional or alternative light sources which have a central wavelength equal or close to an absorption wavelength of the target gas. In another embodiment, one or more tunable light sources can be used to dynamically change the radiated center wavelength by controlling its operating parameters, such as a driving voltage or a driving current. For example, one of the preferred carbon dioxide (CO2) absorption wavelength is around 4.4 microns (i.e., when a light signal of 4.4 microns is radiated onto CO2 gas, the light energy will be absorbed in accordance with the absorption coefficient and the concentration of the CO2). This results in excitation of CO2 molecular energy levels. The excited molecules lose the absorbed light energy through a relaxation process, which causes localized heat release in the gas. The localized heat further induces acoustic and thermal waves in the acoustic resonant gas chamber. Thus, if processor 24 receives an acoustic pressure variation signal from acoustic sensor 22 and if it also determines that a light signal of 4.4 microns is emitted by IR light source then processor 24 identifies that CO2 gas is present in the gas mixture. In one embodiment, the pressure variations in the gas mixture may be represented in terms of a momentum equation which provides gas particle velocity u as:

$${ρ}_{0} \frac{\partial u}{\partial t} = - ∇ p + ( \frac{4}{3} μ + {μ}_{B} ) ∇ ( ∇ \cdot u ) - μ ∇ \times ∇ \times u \qquad ( 1 )$$

where ρ₀ is gas density, t is the time, ∇ is a gradient, p is a pressure in acoustic resonant gas chamber 12, μ is shear viscosity coefficient, and μ_{B} is a bulk viscosity coefficient.

In one embodiment, IR light source 18 includes an array of semiconductor light sources, such as light emitting diodes (LEDs) or laser diodes or super luminescent diodes. In one embodiment IR light source 18 may be modulated directly, i.e., electronic modulation in which semiconductor light sources are selectively turned ON or OFF by controlling light source current. In another embodiment, an external modulation may be utilized wherein an external modulator is placed in front of IR light source 18 which turns the light signal on or off based on the light pulses to be transmitted.

In one embodiment, the number of semiconductor light sources included in the array may be equal to the number of target gases that are to be analyzed in the gas mixture. In this embodiment, each semiconductor light source emits a light signal of specific wavelength. However, in other embodiments, where semiconductor light sources emit the light signal at a spectrum of wavelengths the number of semiconductor light sources used may be less than the number of target gases. In another embodiment, semiconductor light sources may be multiplexed (i.e., the number of semiconductor light sources which are ON at any given time are varied) to generate multiple wavelength light signals. In yet another embodiment, acoustic resonant gas chamber 12 is designed to enable an acoustic resonance which serves to amplify the acoustic signal to allow maximum signal to noise ratio and sensitivity with related constraints. Furthermore, acoustic sensor 22 may include microelectromechanical system (MEMS) microphones, condenser microphones, etc.

Processor 24 receives acoustic signals from acoustic sensor 22 related to gas concentration pressure variations within acoustic resonant gas chamber 12. Processor 24 may also include circuitry for controlling the modulation of IR light source 18, as well as circuitry for receiving and processing signals from acoustic sensor 22. Processor 24 performs calculations on the signals to identify the one or more gases within acoustic resonant gas chamber 12 and a concentration corresponding to each of those gases. Processor 24 also determines concentration of a particular type of gas in the fluid from which it was extracted. In general when a gas mixture is extracted from a fluid, the ratio of gas mixture to the fluid is known. Processor 24 utilizes this ratio of gas mixture to the fluid and the concentration of a target gas in the gas mixture to determine the concentration of the target gas in the fluid. In an embodiment, processor 24 may comprise a microcontroller. As used herein, “processor” means any type of computational circuit, such as but not limited to a microprocessor, a microcontroller, a graphics processor, a digital signal processor (DSP), or any other type of processor or processing circuit.

A memory 26 is used by processor 24 during operation, and may include random access memory (RAM), one or more hard drives, and/or one or more drives that handle removable media. Display 28 indicates the presence and respective concentration values of the target gases within the acoustic resonant gas chamber. Display 28 may comprise any suitable output device, including a video terminal, LED indicator, analog gauge, printer, or other peripheral device. Generally, display 28 indicates concentration measures of a particular gas in terms of percentage, parts per million (ppm) or parts per billion (ppb). Display 28 may also be used to indicate the modulation frequency of IR light source 18.

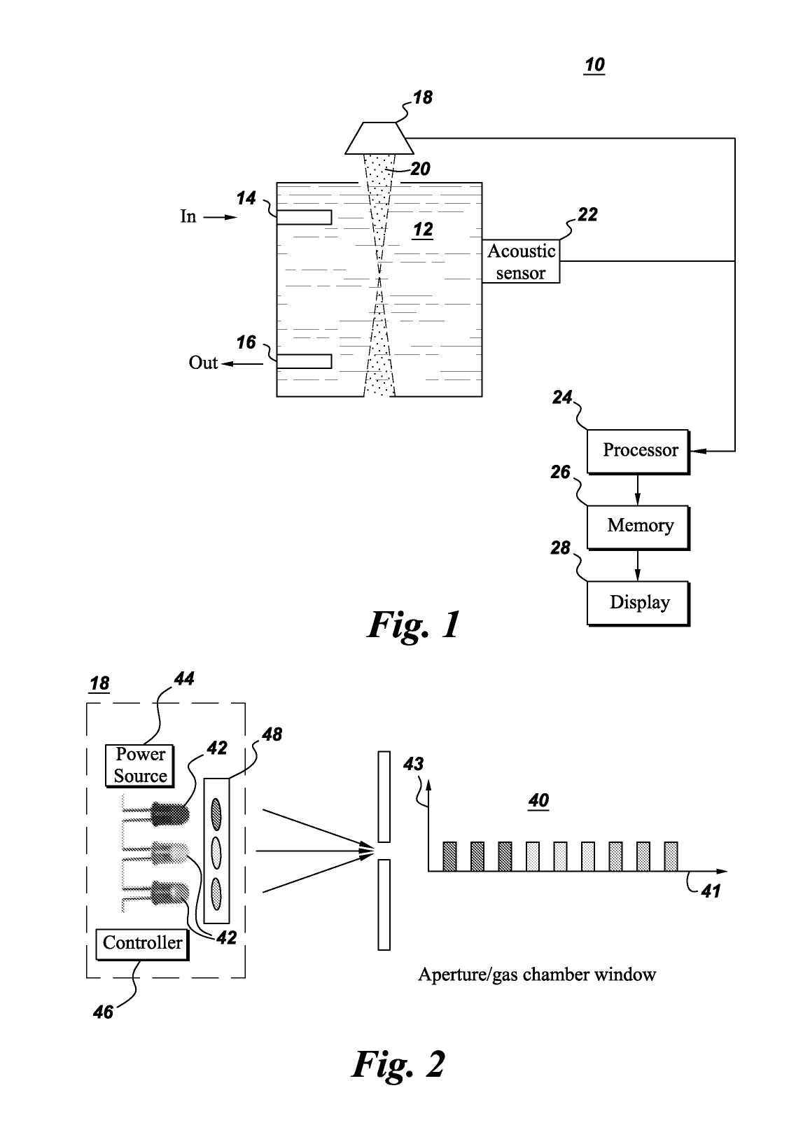

FIG. 2 shows IR light source 18 of FIG. 1 and resultant light signal plot 40 in accordance with an embodiment of the present invention. IR light source 18 includes an array of semiconductor light sources, for example, LEDs 42, a power source 44 to provide power to LEDS 42 and a controller 46 to control LEDs. As discussed earlier, the number of LEDs 42 in the array may be equal to the number of gases that are to be analyzed in the gas mixture.

The central wavelengths of LEDs depend on absorption wavelengths of various types of target gases that are to be analyzed. For example, table 1 below shows absorption wavelengths of some gases.

TABLE 1

| Gas | Wavelength (nm) |
|---|---|
| Acetylene (C2H2) | 3055 |
| Ethylene (C2H4) | 3200 |
| Methane (CH4) | 3262 |
| Ethane (C2H6) | 3349 |
| Carbon Dioxide (CO2) | 4407 |
| Carbon monoxide (CO) | 4678 |

If all of the target gases in Table 1 are to be analyzed or monitored, then IR light source will include 6 LEDs with corresponding center wavelengths as provided in Table 1. The LEDs utilized have narrow bandwidths around this central wavelength so as not to excite other gas molecules or provide a high absorption ratio. For example, as can be seen from Table 1 above, the central wavelengths of Ethylene (C2H4) and Methane (CH4) are very close (i.e., 3200 nm and 3262 nm respectively). Thus, if CH4 is to be analyzed and if the LED selected has a central wavelength of 3300 nm and bandwidth of 100 nm, then it may excite both CH4 and C2H4 making it difficult to differentiate the gases. In another embodiment, a bandwidth of 100 nm may not excite two gases. Thus, in one embodiment, the narrow bandwidth is selected so as not to excite two gases simultaneously. In another embodiment, depending on the gases that are to be analyzed the narrow bandwidth may vary from 50 nm to 300 nm.

In one embodiment, where LEDs of exact center wavelengths or narrow bands are not available then optical filters 48 with narrow pass bands that will filter appropriate wavelengths may be employed. It should be noted that optical filters 48 are optional. In another embodiment, optical filters 48 may be replaced by putting a direct coating on the LED devices.

As can be seen from plot 40, where a horizontal axis 41 represents time and a vertical axis 43 represents amplitude, electromagnetic radiations from LEDs 42 are modulated at a specific frequency in order for the overall system to function properly. A modulation circuit (not shown) is utilized to modulate LEDs 42. The modulation circuit controls turn on and turn off of the LEDs at high frequencies such as kilo hertz or megahertz by controlling a voltage across the LEDs or a current flowing in the LEDs. In general by modulating electromagnetic radiations from LEDs 42, the gas pressure in the chamber varies periodically and spatially, which is measured by the acoustic sensor on the chamber wall. Furthermore, the LEDs 42 are selectively pulsed so as to detect a target gas. The frequency of modulation is dependent on the selected acoustic resonance frequency of acoustic resonant gas chamber 12 and in an embodiment is kept equal to or around the first longitudinal acoustic resonance frequency of acoustic resonant gas chamber 12 to obtain enhanced sensitivity. In one embodiment, the frequency of modulation may be transmitted by processor 24 to controller 46 which then controls modulation of electromagnetic radiations from LEDs 42.

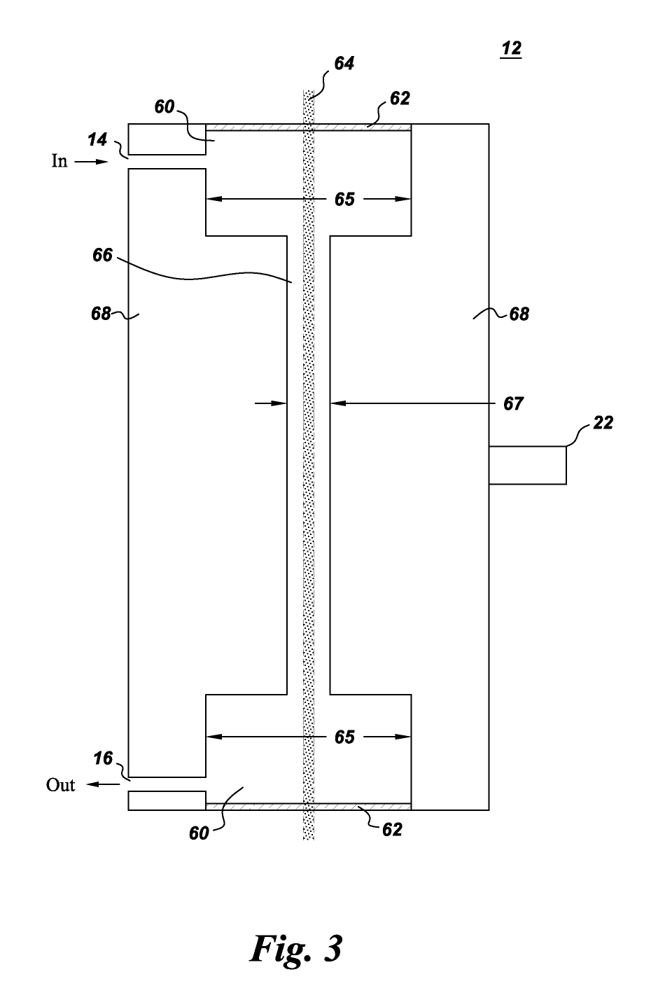

FIG. 3 shows a representative acoustic resonant gas chamber 12 of FIG. 1 in accordance with an embodiment of the present invention. Acoustic resonant gas chamber 12 includes gas inlet 14, gas outlet 16 and an acoustic resonator tube 66 placed between two buffer volumes 60. Two windows 62 at both ends of acoustic resonant gas chamber 12 allow an IR light 64 to pass through acoustic resonant gas chamber 12. The two buffer volumes 60 have larger cross sections 65 than a cross section 67 of acoustic resonator tube 66 which facilitate high acoustic reflections as a sudden change of the cross section is necessary for high acoustic reflections. The Two buffer volume designs 60 can be optimized to minimize flow noise and/or window vibration noise. In one embodiment, acoustic resonator tube 66 extends along a longitudinal axis with respect to the IR light signal; however, other shapes of acoustic resonator tubes 66 corresponding to different acoustic resonant modes are also in scope of the present invention.

Acoustic resonant gas chamber 12 is designed such that it amplifies the pressure variation or acoustic signals of the resonant frequency in order to analyze the gases in more effective way. Acoustic resonant gas chamber 12 will amplify the acoustic signal of the gas molecule vibration if the acoustic resonant gas chambers' resonance frequency matches the modulation frequency of electromagnetic radiations from LEDs. In one embodiment, the resonance frequency of acoustic resonant gas chamber 12 is kept in the range of 0.5K-5 KHz. The various dimensions of acoustic resonant gas chamber 12 such as the length and the radius of acoustic resonator tube 66, its volume can be varied to obtain the desired resonance frequency. In one embodiment, when the resonance frequency fᵣ of acoustic resonant gas chamber 12 may be given as

$${f}_{r} = {c ( {( \frac{{α}_{mn}}{2 R} )}^{2} + {( \frac{p}{2 L} )}^{2} )}^{\frac{1}{2}} \qquad ( 2 )$$

where c is a sound velocity in the gas, R is the radius of the resonator, L is the length of the resonator, p=0, 1, 2, 3 . . . axial mode numbers and αₘₙ is a suitable solution of Bessel equations with m=radial mode number and n=azimuthal mode number. As will be appreciated by those skilled in the art Bessel equation is utilized for solving for patterns of acoustical radiation.

An enclosure 68 of acoustic resonator tube 66 is made up of chemically inert materials for facilitating long-term stability and reliability. Acoustic sensor 22 is located at a point on acoustic resonant gas chamber 12 where the pressure variation is maximum, also referred to as pressure antinode location. For example, for first longitudinal mode operation, this location is at the center of the acoustic resonator tube 66 along the length direction.

In one embodiment, a design model of acoustic resonant gas chamber 12 is simulated a priori utilizing any finite element method (FEM) software or any other relevant software to obtain the acoustic resonant gas chambers' pressure data with respect to various modulation frequencies which is then stored in memory 26. Processor 24 then utilizes this pressure data along with the sensitivity value of acoustic sensor to evaluate acoustic sensor output and thus determines the concentration of a particular gas in the gas mixture. In one embodiment, processor 24 multiplies the pressure data with the acoustic sensor sensitivity specification to evaluate acoustic sensor output.

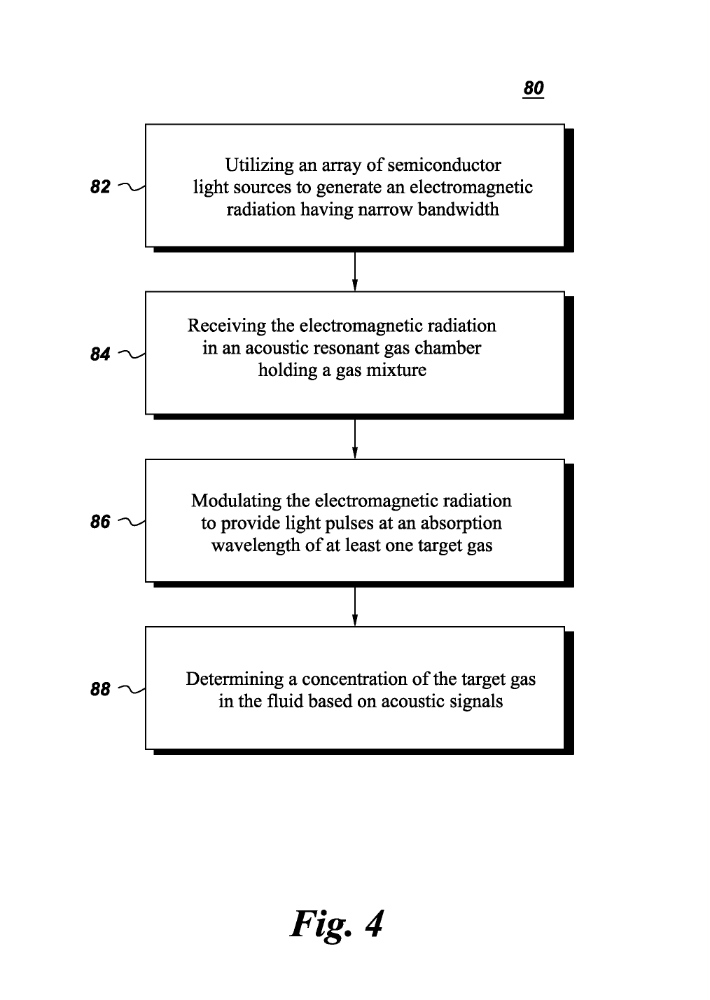

FIG. 4 is a flowchart 80 representing a method of monitoring a gas concentration in a fluid in accordance with an embodiment of the present invention. At step 82, the method includes utilizing an array of semiconductor light sources such as LEDs to generate an electromagnetic radiation having narrow bandwidth. The array of semiconductor light sources is reconfigurable according to the choice of gases to be analyzed.

At step 84, the method includes receiving the electromagnetic radiation in an acoustic resonant gas chamber which has a gas mixture. The gas mixture is extracted from a fluid and the ratio of gas mixture to the fluid is known. The acoustic resonant gas chamber is designed to amplify acoustic signals emanating from the gas mixture. At step 86, the method includes modulating the electromagnetic radiation to provide light pulses at an absorption wavelength of at least one target gas. The frequency of modulation of the electromagnetic radiation is generally kept equal to or around a selected acoustic resonance frequency of the acoustic resonant gas chamber so as not to activate motion in other gases. In step 88, the method includes determining a concentration of the target gas in the fluid based on acoustic signals emanating from inside the acoustic resonant gas chamber corresponding to pressure variations in the chamber. In one embodiment, the concentration of the target gas is determined by a processor based on a pressure data with respect to the modulation frequency and the acoustic sensor sensitivity specification. Furthermore, determining a concentration of the target gas dissolved in the fluid comprises determining a target gas concentration in the gas mixture and then utilizing the ratio of the gas mixture to the fluid to determine the gas concentration in the fluid.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for analyzing gas concentrations in a gas mixture comprising:
an array of semiconductor light sources configured to generate an electromagnetic radiation having a narrow bandwidth;
a controller to modulate the electromagnetic radiation at a modulating frequency to provide light pulses at an absorption wavelength of at least one target gas;
an acoustic resonant gas chamber to hold the gas mixture and configured to receive the light pulses and amplify acoustic signals emanating from the gas mixture; and
a processor to determine a concentration of the target gas based on acoustic signals.

2. The system of claim 1, wherein a number of semiconductor light sources in the array is determined based on a number of target gases that are to be monitored.

3. The system of claim 2, wherein central wavelengths of each of the semiconductor light sources are based on absorption wavelengths of the target gases to be monitored.

4. The system of claim 3, wherein each of the semiconductor light sources have a narrow bandwidth around the central wavelengths.

5. The system of claim 1, wherein the semiconductor light sources include light emitting diodes (LEDs) or laser diodes or super luminescent diodes

6. The system of claim 1, further comprising optical filters to filter the electromagnetic radiation from the array of semiconductor light sources.

7. The system of claim 6, wherein optical filters comprise direct coatings on semiconductor light source.

8. The system of claim 1, wherein the modulation frequency is dependent on an acoustic resonance frequency of the acoustic resonant gas chamber.

9. The system of claim 1, wherein the acoustic resonant gas chamber comprises an acoustic resonator tube extending along a longitudinal axis of the acoustic resonant gas chamber and the acoustic resonator tube is configured to amplify the acoustic signals.

10. The system of claim 9, wherein a resonance frequency of the acoustic resonator tube is in the range of 0.5 KHz-5 KHz.

11. The system of claim 9, wherein the acoustic resonator tube is disposed between two buffer volumes each having larger cross section than that of the acoustic resonator tube.

12. The system of claim 11, wherein two buffer volumes are designed to minimize a flow noise and a window vibration noise.

13. The system of claim 1 further comprising an acoustic transducer to measure the acoustic signals emanating from the gas mixture.

14. The system of claim 13, wherein the processor utilizes a pressure data with respect to modulation frequencies of the acoustic resonant gas chamber along with a sensitivity specification of the acoustic transducer to determine the concentration of the target gas in the acoustic resonant gas chamber.

15. The system of claim 14, wherein the pressure data is obtained a priori by simulating a model of the acoustic resonant gas chamber in finite element method (FEM) software.

16. A method of monitoring dissolved gases in a fluid comprising:
utilizing an array of semiconductor light sources to generate an electromagnetic radiation having a narrow bandwidth;
receiving the electromagnetic radiation in an acoustic resonant gas chamber holding a gas mixture extracted from the fluid, wherein the acoustic resonant gas chamber is designed to amplify acoustic signals emanating from the gas mixture;
modulating the electromagnetic radiation to provide light pulses at an absorption wavelength of at least one target gas; and
determining a concentration of the target gas dissolved in the fluid based on the acoustic signals.

17. The method of claim 16, wherein determining a concentration of the target gas dissolved in the fluid comprises determining a target gas concentration in the gas mixture.

18. The method of claim 16, wherein modulating the electromagnetic radiation comprises external modulation of the electromagnetic radiation or direction modulation of the electromagnetic radiation.

19. The method of claim 18, wherein the direct modulation includes controlling a semiconductor light source current.
